(19) United States
(12) Patent Application Publication
(10) Pub. No.: US 2018/0037139 A1
(43) Pub. Date: Feb. 8, 2018

(54) OCCUPANT IDENTIFICATION FOR SEAT ASSEMBLIES

(71) Applicant: Lear Corporation, Southfield, MI (US)

(72) Inventors: Gerald PATRICK, Shelby Township, MI (US); Samuel HANLON, Livonia, MI (US); Michelle A. PERENY, Farmington Hills, MI (US); David HAYNER, Waco, TX (US)

(21) Appl. No.: 15/227,097

(22) Filed: Aug. 3, 2016

(51) Int. Cl. B60N 2/02; A47C 7/00; B60N 2/00

(52) U.S. Cl. CPC B60N 2/0244; B60N 2/002; A47C 7/00; B60N 2/0232; B60N 2002/0268

(57) ABSTRACT

A seat assembly is provided with a seat bottom, a seat back, and a plurality of sensors operably connected to at least one of the seat bottom and the seat back to detect a seating condition of a seated occupant. A controller is in electrical communication with the plurality of sensors and the at least one actuator. The controller is programmed to receive input from the plurality of sensors indicative of a seating condition of the seated occupant. The seating condition of the seated occupant is compared to stored seating conditions of prior seat occupants to determine that the seated occupant is a prior occupant.

### TECHNICAL FIELD

Various embodiments relate to occupant identification of seated occupants in seat assemblies.

### BACKGROUND

Galbreath et al. U.S. Patent Application Publication US 2012/0096960 A1, which published on Apr. 26, 2012, discloses a system that generates dynamic seating body distribution data.

### SUMMARY

According to at least one embodiment, a seat assembly is provided with a seat bottom, a seat back, and a plurality of sensors operably connected to at least one of the seat bottom and the seat back to detect a seating condition of a seated occupant. A controller is in electrical communication with the plurality of sensors and the at least one actuator. The controller is programmed to receive input from the plurality of sensors indicative of a seating condition of the seated occupant. The seating condition of the seated occupant is compared to stored seating conditions of prior seat occupants to determine that the seated occupant is a prior occupant.

According to at least another embodiment, a computer-program product is embodied in a non-transitory computer readable medium that is programmed for identifying an occupant of a seat assembly. The computer-program product comprises instructions for receiving input from a plurality of sensors of a seat assembly indicative of a seating condition of a seated occupant. The seating condition of the seated occupant is compared to stored seating conditions of prior seat occupants to determine that the seated occupant is a prior occupant.

According to at least another embodiment, a method for identifying an occupant of a seat assembly is provided by receiving input from a plurality of sensors of a seat assembly indicative of a seating condition of a seated occupant. The seating condition of the seated occupant is compared to stored seating conditions of prior seat occupants to determine that the seated occupant is a prior occupant.

### BRIEF DESCRIPTION OF THE DRAWINGS

FIG. 1 is a front perspective view of a vehicle seat assembly, illustrated partially disassembled, according to an embodiment; and

FIG. 2 is a flow chart of a method for identifying an occupant according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

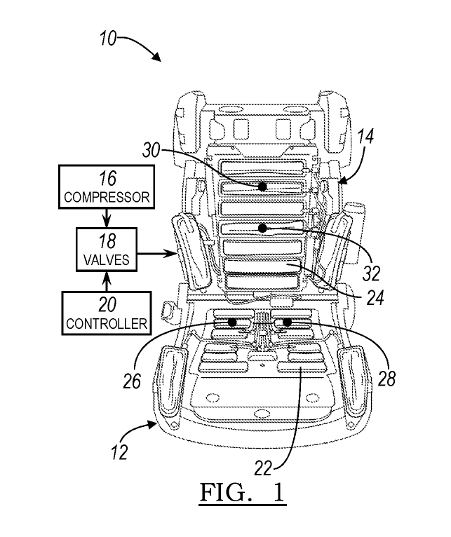

FIG. 1 illustrates the vehicle seat assembly 10 with a cover removed. The vehicle seat assembly 10 may be employed in an automotive vehicle, an aircraft, a watercraft or the like. Alternatively, the seat assembly 10 may be employed in a non-transportation environment, such as an office chair, or the like. Moreover, the vehicle seat assembly 10 may be employed in any environment wherein it is desirable to identify the occupant.

The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for motor-driven pivotal adjustment relative to the seat bottom 12. A head restraint (not shown) is mounted for motor-driven adjustable translation to the seat back 14.

At least one compressor 16 may provide a source of air to the seat assembly 10. A plurality of valves 18 receive the compressed air and are controlled by a controller 20 for regulating compressed air into and out of the seat assembly 10. The seat bottom 12 includes a plurality of air bladders 22. The seatback 14 also includes a plurality of air bladders 24. The valves 18 may be provided as a common valve bank that is housed in the seat back 14 or under the seat bottom 12; or the valves 18 may each be provided on each of the air bladders 22, 24. The compressor 16 may be provided in the seat back 14, the seat bottom 12 or concealed within the vehicle body. The controller 20 may be provided in a module under the seat bottom 12, and may be a multifunction controller that also controls other functions in the vehicle.

The prior art offers various systems for identifying an occupant. The systems may include identification of a user input on a key fob that is communicated to a seat controller. Prior art systems may also require manual input of identification of a user, such as a mode selector. Identification upon a key fob is subject to misidentification when multiple users may share a key fob. Manual input requires an additional step from the user. The seat assembly 10 identifies a user based upon dynamic readings of the user.

The seat assembly 10 includes an array of sensors 26, 28, 30, 32 for detecting a seating condition of a seated occupant. According to one embodiment, each sensor 26, 28, 30, 32 may include a three-axis accelerometer, and a three-axis gyroscope to provide a six-axis inertial sensor. The sensors 26, 28, 30, 32 detect occupant seating position and movement. The sensors 26, 28, 30, 32 are in electrical communication with the controller 20 for conveying the detected information to the controller 20.

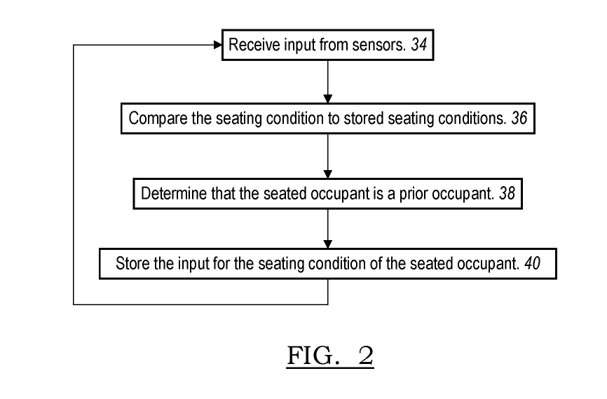

Referring to FIG. 2, at block 34, the controller 20 receives the input from the sensors 26, 28, 30, 32. At block 36, the input seating condition is compared to prior seating conditions, as long as prior seating conditions are stored. At block 38, the controller 20 determines if the seated occupant is a prior occupant. If so, this identification may be employed to adjust the seat to a stored seating position. The stored seating position may be one previously stored by the occupant, or a prescribed seating position for an occupant based on anthropometric data.

If the controller 20 does not identify the seated occupant, the seating conditions are stored at block 40 for future identification. Alternatively, if the occupant is identified, the seating condition may be stored at block 40 to establish a range of seating conditions for the identified occupant.

The steps in blocks 34-40 are repeated for tracking of the occupant. Thus, as the occupant moves, new seating conditions are measured at block 34. The measured seating conditions are compared to stored seating conditions at block 36 to determine if the seated occupant is a prior occupant at block 38. If the seated occupant was not identified based upon the first seating condition, the seated occupant may be identified at a second or subsequent seating condition. As described above, the input of the second seating condition is stored at block 40 for subsequently identifying the occupant. The data may also be stored for determining a range and/or tolerance of seating conditions for identifying the occupant.

The controller 20 may also be in communication with a vehicle control module to receive information pertaining to a vehicle driving condition. For example, an occupant may sit differently for performance driving than leisure driving. Such conditions may also be input to the controller 20 for identifying seating conditions associated with driving conditions for occupants. Likewise, the driving condition can be stored with seating condition for future comparison and identification.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a seat bottom;
a seat back;
a plurality of sensors operably connected to at least one of the seat bottom and the seat back to detect a seating condition of a seated occupant; and
a controller in electrical communication with the plurality of sensors and the at least one actuator, the controller being programmed to:
receive input from the plurality of sensors indicative of a seating condition of the seated occupant,
compare the seating condition of the seated occupant to stored seating conditions of prior seat occupants, and
determine that the seated occupant is a prior occupant.

2. The seat assembly of claim 1 wherein the plurality of sensors comprise a plurality of inertial sensors.

3. The seat assembly of claim 1 wherein the plurality of sensors comprise a plurality of accelerometers.

4. The seat assembly of claim 1 wherein the plurality of sensors comprise a plurality of gyroscopes.

5. The seat assembly of claim 1 wherein the plurality of sensors comprise a plurality of six-axis sensors.

6. The seat assembly of claim 1 wherein the plurality of sensors comprise an array of four sensors.

7. The seat assembly of claim 1 wherein the controller is further programmed to store the input for the seating condition of the seated occupant.

8. The seat assembly of claim 7 wherein the controller is further programmed to receive input from the plurality of sensors indicative of a second seating condition of the seated occupant.

9. The seat assembly of claim 8 wherein the controller is further programmed to store the input for the second seating condition of the seated occupant.

10. The seat assembly of claim 8 wherein the controller is further programmed to:
compare the second seating condition for the seated occupant to stored seating conditions of prior occupants; and
determine that the seated occupant is a prior occupant.

11. The seat assembly of claim 8 wherein the controller is further programmed to determine a range of seating conditions for the seated occupant from the stored seating conditions.

12. The seat assembly of claim 8 wherein the controller is further programmed to determine a tolerance for at least one of the stored seating conditions of the seated occupant for further determination of the seated occupant.

13. The seat assembly of claim 12 wherein the controller is in electrical communication with a vehicle control module, and the controller is further programmed to:
receive input indicative of a vehicle driving condition from the vehicle control module; and
store the input for the vehicle driving condition with the stored seating condition.

14. The seat assembly of claim 13 wherein the controller is further programmed to:
compare the stored seating condition and the stored vehicle driving condition to stored seating conditions and vehicle driving conditions of prior seat occupants; and
determine that the seated occupant is a prior occupant.

15. The seat assembly of claim 1 further comprising at least one actuator operably connected to at least one of the seat bottom and the seat back for adjustment of at least one of a plurality of settings of the seat assembly.

16. The seat assembly of claim 15 wherein the controller is further programmed to adjust the at least one actuator to a predetermined setting corresponding to the prior occupant.

17. A computer-program product embodied in a non-transitory computer readable medium that is programmed for identifying an occupant of a seat assembly, the computer-program product comprising instructions for:
receiving input from a plurality of sensors of a seat assembly indicative of a seating condition of a seated occupant;
comparing the seating condition of the seated occupant to stored seating conditions of prior seat occupants; and
determining that the seated occupant is a prior occupant.

18. The computer-program product of claim 17 further comprising instructions for storing the input for the seating condition of the seated occupant.

19. The computer-program product of claim 18 further comprising instructions for receiving input from the plurality of sensors indicative of a second seating condition of the seated occupant.

20. A method for identifying an occupant of a seat assembly, the method comprising steps of:
receiving input from a plurality of sensors of a seat assembly indicative of a seating condition of a seated occupant;
comparing the seating condition of the seated occupant to stored seating conditions of prior seat occupants; and
determining that the seated occupant is a prior occupant.
